(19) United States
(12) Patent Application Publication
(10) Pub. No.: US 2026/0030261 A1
(43) Pub. Date: Jan. 29, 2026

(54) Multi-Level Deep Learning Model

(71) Applicant: Peter Ernest Lenz, Valhalla, NY (US)

(72) Inventor: Peter Ernest Lenz, Valhalla, NY (US)

(21) Appl. No.: 18/785,332

(22) Filed: Jul. 26, 2024

(51) Int. Cl. G06F 16/28; G06F 16/22; G06N 3/0475

(52) U.S. Cl. CPC G06F 16/285; G06F 16/2237; G06N 3/0475

(57) ABSTRACT

A system and method for predicting the truth of a statement, said system being trained on true and false statements generated by a large language model.

### CROSS-REFERENCE TO RELATED APPLICATION

This application claims the benefit of U.S. Provisional Patent Application No. 63/515,827, filed Jul. 26, 2023, which is incorporated by reference herein in its entirety.

### FIELD OF THE INVENTION

This disclosure pertains to machine learning models, semantic networks, adaptive systems, artificial neural networks, convolutional neural networks, natural language processing, and other forms of knowledge processing systems.

### DESCRIPTION OF THE RELATED ART

Natural Language Processing (“NLP”) is a subfield of artificial intelligence and computational linguistics that focuses on the interaction between computers and human language. Early NLP methods focused on rule-based systems and semantics, but could not overcome limitations on capturing contextual information.

Subsequent NLP methods employed neural language models that use neural nets to learn the statistical properties of natural language. One notable development is Word2Vec (Mikolov 2013). Word2vec employs a shallow neural net with one hidden layer, which it trains on a large corpus of text, and then determines a vector of values for each word in the corpus. Each vector consists a set of weights on the trained net.

For example, one Word2vec implementation, continuous-bag-of-words (“CBOW”), attempts to predict a target word based on its context. CBOW uses the hidden layer's input weights for a word's vector representation. The CBOW net is trained by adjusting the hidden layer's input weights based on the difference between the predicted word and the actual target word.

In contrast, another word2vec implementation, known as Skip-Gram, attempts to predict the surrounding words given a target word. In this implementation, a word's vector representation, also known as its word embedding, is also derived from weights in the trained model. The Skip-Gram model is also trained by adjusting the word vectors to optimize the prediction of similar words in context.

In addition to the CBOW and Skip-Gram, several other variants of the Word2Vec algorithm have been developed. One variant, Global Vectors for Word Representation (“GloVe”), which leverages global word co-occurrence statistics to learn word embeddings. Another variant, Hierarchical Softmax, organizes the vocabulary into a binary tree structure, which allows for efficient computation during training thus reducing the computational cost of the softmax function by logarithmic factor. Another variant, CBOW with Subword Information, handles out-of-vocabulary words and morphological variations, enabling the generation of meaningful embeddings for rare or unseen words. Another variant, Doc2Vec, extends the approach to learn document-level embeddings, capturing the semantic representation of entire documents, paragraphs, or sentences by associating a vector with each piece of text. These and other variants address specific challenges in word representation learning, each capturing different linguistic characteristics and improving the quality of word embeddings in specific contexts.

Once the word vectors are generated by word2vec or similar methods, they can be considered standalone representations of words in a continuous vector space, and stored separately from the neural network model that generated them. Thus, NLP tasks like similarity and analogy can be reduced to simple vector mathematics operations such as distance, addition, and subtraction. Word vectors can also be used as training data for subsequent machine learning tasks such as classification and named entity recognition (“NER”).

One training algorithm for Word2Vec uses a technique called negative sampling, which approximates the probability of a word appearing in a given context. By sampling a small number of negative examples (words not appearing in the context), the model learns to differentiate between positive (true/factual) and negative (false/counterfactual) word-context pairs efficiently. The scalability and efficiency of Word2Vec have facilitated its application to large-scale datasets.

Several implementations of trained neural nets have been made available to the public, including OpenAl's Generative Pretrained Model (“GPT”) and Google's Bidirectional Encoder Representations from Transformers (“BERT”). Each of these language models has been trained on massive corpora of text and fine-tuned for specific tasks such as understanding language, sentiment analysis (also known as opinion mining), answering questions and generating text.

The BERT model uses bidirectional context in language understanding, compared to previous models' use of a unidirectional approach. BERT trains a masked language model that predicts missing words in a sentence bidirectionally, enabling to grasp the meaning of words within the context of their surrounding words. BERT is pre-trained on a massive corpus of text from various sources, including books and websites, enabling the model to learn general language representations and capture rich semantic information. After pre-training, BERT is fine-tuned on specific downstream tasks by adding task-specific layers and training on task-specific datasets. This fine-tuning process enhances the model's performance on various NLP tasks, such as question-answering, sentiment analysis, and NER. BERT has been released as an open-source model, and researchers and practitioners worldwide have adopted and built upon BERT.

Neural networks can also be used to evaluate graph data, i.e., structured data comprising nodes and edges. Graph Neural Networks (“GNNs”) (Scarselli, 2008) can be trained to operate directly on graph data including social networks, knowledge graphs, biological networks as well as any graph that represents entities and relationships between them. A GNN represents each node in the input graph as a learnable feature vector. GNNs can be used to perform such tasks as node classification, edge prediction, graph classification, graph generation, and providing recommendations.

Another GNN implementation is GraphSAGE, a framework for inductive representation learning on large-scale graphs (Hamilton, et al., 2017). Inductive learning allows the model to generalize to unseen nodes. GraphSAGE leverages the idea of aggregating information from a node's local neighborhood to generate its representation, and uses a trainable aggregator function that learns to aggregate neighborhood information efficiently. The aggregator can be either a mean aggregator, a pooling aggregator, or an LSTM-based aggregator, depending on the desired trade-off between model complexity and expressive power.

Graph edge prediction refers to the task of predicting the existence or likelihood of an edge between two nodes in a graph. Graphs are widely used to model complex relationships in various domains, such as social networks, biological networks, citation networks, and knowledge graphs. In the case of incomplete or partially observed graphs, the goal is to infer missing edges or predict the likelihood of future connections based on the available information in the graph.

A graph triplet, also known as a triple or a triple statement, is a fundamental unit of information in knowledge graphs and semantic networks. It consists of three components: a subject, a predicate, and an object. Graph triplets are used to represent relationships between entities in a graph. For example, a triplet with a subject of “France” a predicate of “CapitalCity” and an object of “Paris” is a representation that Paris is the capital of France. Note that a graph triplet does not necessarily embody correct or true information: A triplet with a subject of France, a predicate of “CapitalCity” and a subject of “Boston” (a representation that Boston is the capital of France) is as equally well-formed as the preceding, factually correct, triplet. The components of triplets are also known as head entity, relation, and tail entity.

Another GNN implementation, TransE, learns embeddings for entities and relations in multi-relational data such as a knowledge graph (Bordes, et al., 2013). The TransE model is based upon the supposition that in a valid triple, the subject and predicate should be close to each other in their representations in vector space, which enables the object to be inferred. Also that the predicate vector can be seen as a translation vector, and that a scoring function can be based on how well the predicate translates the subject to the object.

LLMs are known to be an unreliable source of truth, and can in fact be made to deliberately generate fictional content. One such knowledge base, Galactica (Shane, 2022), is designed to generate fictional information. The Galactica model is trained on textual data including books, movies, and other fictional works. The training process involves teaching the model to understand the patterns, themes, and structures commonly found in fictional content.

Software libraries are available for NLP and training neural language models, providing a high-level abstraction for complex NLP tasks. These libraries include the Python Natural Language Toolkit (“NLTK”) library, the Python TextaCy library, and the Python SpaCy library. These libraries can be used to perform a wide variety of NLP tasks such as corpus ingestion, corpus management, training, text extraction, text cleaning, text processing, tokenization, part-of-speech tagging, classification, and NER. Other libraries include Facebook's Llama.

The world wide web can be used as a source of large corpora for training large language models (Seitner, 2016). Tools are available for treating web pages as a structured data source, enabling extraction, integration, and querying of structured information from web pages. These approaches include web scraping, information extraction, and data integration. However, there are challenges such as data quality and scalability, and the need for robust methods to deal with these challenges is recognized.

In machine learning, counterfactual statements are used to estimate causal effects and make causal inferences. Specifically, they can be used to explore the behavior of large language models and shed light on how they internally represent semantic information, as well as gain insights on the model's decision-making process. (Linyi Yang et al., 2020). Methods for generating these counterfactuals include Distilling Phrasal Counterfactuals (“DISCO”), which does so by leveraging the knowledge and capabilities of large language models. (Chen et al., 2022) The DISCO model is trained by using a dataset of paired examples consisting of factual sentences and their corresponding counterfactuals.

### SUMMARY OF THE INVENTION

A true/false classifier and a method of use is disclosed. In a first aspect, the true/false classifier is constructed by prompting a Large Language Model (“LLM”) for a factual statement and a counterfactual statement, and using a Natural Language Processing (“NLP”) method on each statement to determine a relationship between the subject and object of each statement. In this aspect, these statements are converted to vectorized form via the aggregated output of a Vector Dictionary. In a further aspect, each relationship is normalized to an enumerated set of possible relationships.

In a second aspect, the true/false classifier is used to determine the truth or falsehood of a statement consisting of a subject, an object, and a relationship between them.

In a third aspect, the true/false classifier is used to assay the quality of an arbitrary Large Language Model by comparing the results when both the true/false classifier and the LLM are queried regarding the truth of a statement consisting of a subject, an object, and a relationship between them.

In a fourth aspect, two arbitrary Large Language Models are compared by assaying each model's quality using the true/false classifier. In a further aspect a first LLM is compared to a second LLM with a known level of trust.

### BRIEF DESCRIPTION OF FIGURES

FIG. 1 depicts a dataflow diagram of the construction of a standardized Vectorized Triplet.

FIG. 2 depicts a dataflow diagram of the construction of a Vectorized Triplet where relationships that are not within a pre-set distance limit are discarded.

FIG. 3 depicts a dataflow diagram of the construction of a Vectorized Triplet with a relationship selected from a set of pre-defined relationships.

FIG. 4 depicts a dataflow diagram of the construction of a vector dictionary.

FIG. 5 depicts a dataflow diagram of the construction of a relationship vector dictionary.

FIG. 6 depicts a schematic diagram of a graph triplet representing a factual statement.

FIG. 7 depicts a schematic diagram of a graph triplet representing a counterfactual statement.

FIG. 8 depicts a dataflow diagram of the construction and comparison of a standardized factual Vectorized Triplet and a standardized counterfactual Vectorized Triplet.

### DETAILED DESCRIPTION OF THE INVENTION

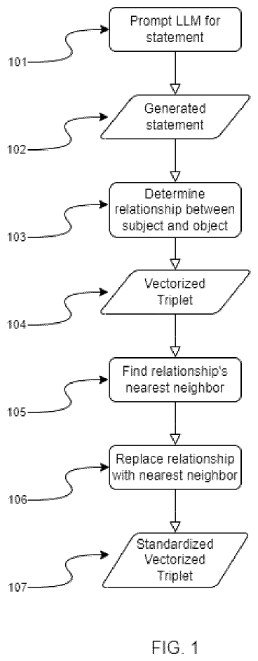

FIG. 1 depicts a dataflow diagram of the construction of a standardized Vectorized Triplet. To generate a Vectorized Triplet, a Large Language Model (“LLM”) is prompted 101 to generate a statement 102 about a specified subject and a specified object. The generated statement 102 is then fed into a machine learning (“ML”) model to determine 103 the relationship between the subject and object set out in the generated statement 102. The vectorized values of the subject, object, and relationship are extracted from the ML model to produce a Vectorized Triplet 104. The Vectorized Triplet 104 is then standardized by searching 105 a vectorized dictionary of predefined relationships for the determined relationship's nearest neighbor. The distance metric used can be Euclidian distance. The Vectorized Triplet's relationship is then replaced 106 with the vector of the nearest neighbor, producing the standardized Vectorized Triplet 107.

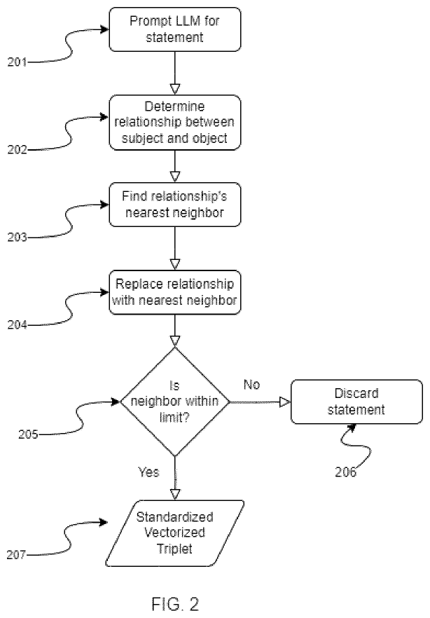

FIG. 2 depicts a dataflow diagram of the construction of a standardized Vectorized Triplet 207 where relationships that are not within a pre-set distance limit are discarded. To generate a Vectorized Triplet, a Large Language Model (“LLM”) is prompted 201 to generate a statement about a specified subject and a specified object. The generated statement is then fed into a machine learning (“ML”) model to determine 202 the relationship between the subject and object set out in the generated statement. The vectorized values of the subject, object, and relationship are extracted from the ML model to produce a Vectorized Triplet. The Vectorized Triplet is then standardized by searching 203 a vectorized dictionary of predefined relationships for the determined relationship's nearest neighbor. The distance metric used can be Euclidian distance. The Vectorized Triplet's relationship is then replaced 204 with the vector of the nearest neighbor. Finally, the nearest neighbor's distance is compared 205 to a predetermined distance limit. If the distance is greater than the limit, the entire statement and its Vectorized Triplet is discarded 206. If the distance is within the limit, a standardized Vectorized Triplet 207 is produced.

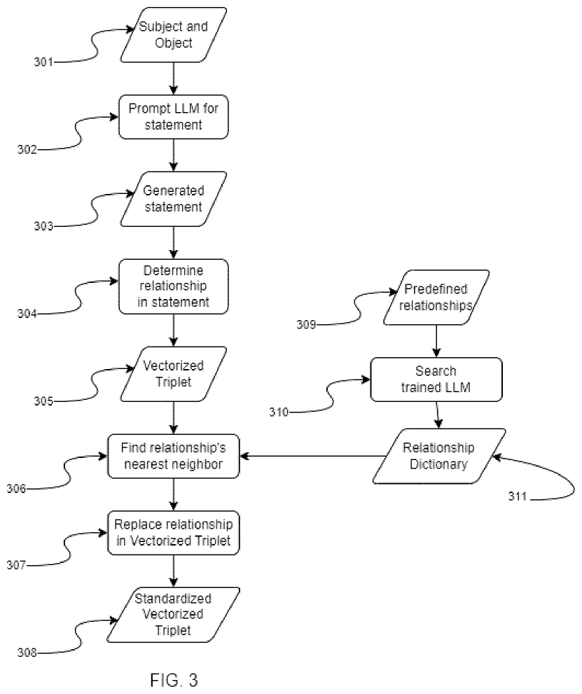

FIG. 3 depicts a dataflow diagram of the construction of a standardized Vectorized Triplet 308 with a relationship selected from a set of pre-defined relationships. To generate a Vectorized Triplet, a Large Language Model (“LLM”) is prompted 302 to generate a statement 303 about a specified subject and object 301. The generated statement 303 is then fed into a machine learning (“ML”) model to determine 304 the relationship between the subject and object set out in the generated statement 303. The vectorized values of the subject, object, and relationship are extracted from the ML model to produce a Vectorized Triplet 104. The relationship in the Vectorized Triplet 305 is then compared to a Relationship Dictionary 311. The Relationship Dictionary 311 is generated by searching 306 a trained Large Language Model (“LLM”) for a list of allowed relationships 309 and extracting their vectorized values. The Relationship Dictionary 311 is searched 306 for the nearest neighbor to the relationship in the Vectorized Triplet 305. Examples of distance metrics include but are not limited to Euclidian distance, cosine similarity, Minkowski distance, Hamming distance, and correlation distance. The Vectorized Triplet 305's relationship is then replaced 307 with the Relationship Dictionary 311′s nearest neighbor, producing a standardized Vectorized Triplet 308.

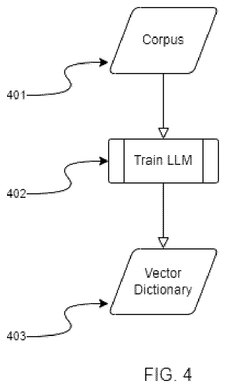

FIG. 4 depicts a dataflow diagram of the construction of a vector dictionary. A corpus 401, which is typically a collection of text documents, is used to train 402 a Large Language Model (“LLM”). Examples of LLMs include but are not limited to: word2vec, Global Vectors for Word Representation (“GloVE”), FastText, and Embeddings from Language Models (“ELMo”). The vector values of words in the corpus can then be extracted from the LLM to produce a Vector Dictionary 403. It is not necessary for the entire corpus to be extracted. For example, FIG. 3's Relationship Dictionary 311 consists of extracted vector values for a subset of selected terms.

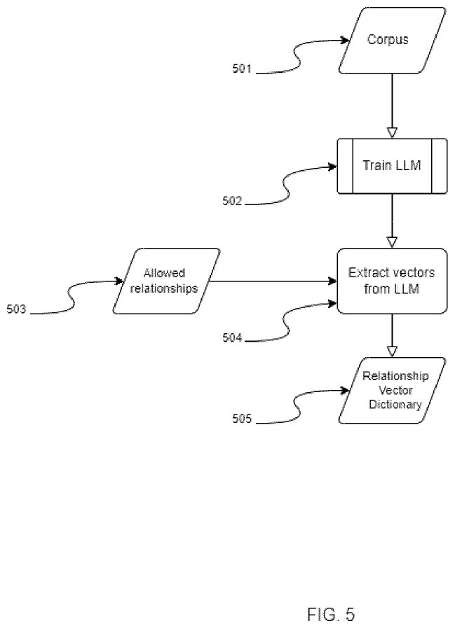

FIG. 5 depicts a dataflow diagram of the construction of a Relationship Vector Dictionary 505. A corpus 501, which is typically a collection of text documents, is used to train 502 a Large Language Model (“LLM”). Examples of LLMs include but are not limited to: word2vec, Global Vectors for Word Representation (“GloVE”), FastText, and Embeddings from Language Models (“ELMo”). A list of allowed relationships 503 are then extracted 504 from the LLM, producing the Relationship Vector Dictionary 505.

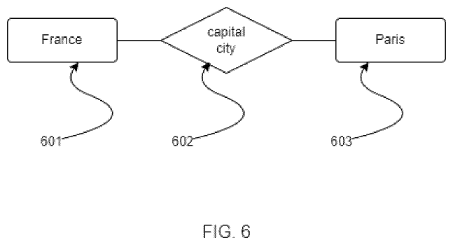

FIG. 6 depicts a schematic diagram of a graph triplet representing the statement “Paris is the capital of France.” The statement is represented as a subject 601, an object 603, and a relationship 602. Here the subject 601 is “France”, the object 603 is “Paris”, and the relationship 602 is “the capital city of”. The represented statement happens to be factual, but the graph triplet can also be used to represent counterfactual statements.

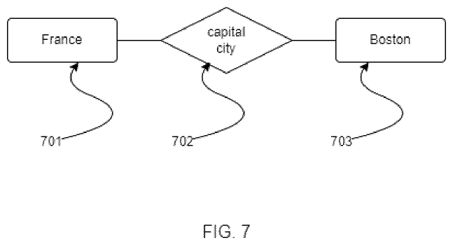

FIG. 7 depicts a schematic diagram of a graph triplet the statement “Boston is the capital of France.” The statement is represented as a subject 701, an object 703, and a relationship 702. Here the subject 701 is “France”, the object 703 is “Boston”, and the relationship 702 is “the capital city of”. The represented statement happens to be counterfactual, but the graph triplet can also be used to represent factual statements.

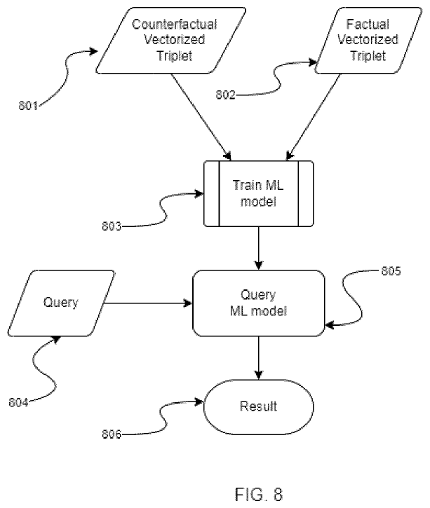

FIG. 8 depicts a dataflow diagram of the construction and use of a true/false classifier. A plurality of counterfactual Vectorized Triplets 801 and a plurality of factual Vectorized Triplets 802 are used to train 803 a machine learning (“ML”) model. All of the Vectorized Triplets 801, 802 are tagged in the ML as factual or counterfactual. A statement 804 is submitted 805 to the trained ML model. The ML model then returns a result 806 reflecting the ML model's prediction of if the statement 804 is factual or counterfactual.

1. A method of creating a true/false classifier comprising the steps of:
prompting a Large Language Model for a factual statement about a first subject and a first object,
prompting said Large Language Model for a counterfactual statement about a second subject and a second object,
using a Natural Language Processing method on said factual statement to determine a first relationship between said first subject and said first object,
using said Natural Language Processing method on said counterfactual statement to determine a second relationship between said second subject and said second object,
creating a first Vectorized Triplet comprising:
a vectorized first subject, comprising the aggregated output of a Vector Dictionary for said first subject,
a vectorized first object, comprising the aggregated output of said Vector Dictionary for said first object, and
a vectorized first relationship, comprising the aggregated output of said Vector Dictionary for said first relationship,
creating a second Vectorized Triplet comprising
a vectorized second subject, comprising the aggregated output of a Vector Dictionary for said second subject
a vectorized second object, comprising the aggregated output of said Vector Dictionary for said second object, and
a vectorized second relationship, comprising the aggregated output of said Vector Dictionary for said second relationship,
finding a first nearest neighbor to said vectorized first relationship by searching a Relationship Dictionary using a distance metric,
replacing said vectorized first relationship with that of said first nearest neighbor,
finding a second nearest neighbor to said vectorized second relationship by searching said Relationship Dictionary using said distance metric, and
replacing said vectorized second relationship with that of said second nearest neighbor.

2. The true/false classifier of claim 1 wherein said first Vectorized Triplet is discarded if the distance of said first nearest neighbor is greater than a maximum distance limit.

3. The true/false classifier of claim 2 wherein said second Vectorized Triplet is discarded if the distance of said second nearest neighbor is greater than said maximum distance limit.

4. The Vector Dictionary of claim 1 wherein a set of high frequency words have been deleted.

5. The true/false classifier of claim 1 wherein said first subject is identical to said second subject.

6. The true/false classifier of claim 1 wherein said first object is identical to said second object.

7. The true/false classifier of claim 1 wherein said Vector Dictionary is produced by passing a set of documents through a neural network.

8. The true/false classifier of claim 7 wherein said neural network is an implementation selected from the set consisting of: word2vec, transformer, glove, fasttext.

9. The true/false classifier of claim 1 wherein said Natural Language processing method is selected from the group consisting of: part of speech tagging and dependency tagging.

10. The true/false classifier of claim 1 wherein said aggregated output of said Vector Dictionary is averaged output.

11. The true/false classifier of claim 1 wherein said distance metric is selected from the set consisting of: Euclidean distance.

12. The true/false classifier of claim 1 wherein said Relationship Dictionary comprises a vector dictionary containing a set of allowed relationships.

13. A method of establishing the truth or falsity of a statement, wherein said statement comprises a subject, an object, and a relationship, comprising the step of submitting said statement to the true/false classifier constructed according to claim 1.

14. A method for assaying the quality of a Large Language Model, comprising the steps of:
constructing a statement comprising a subject, an object, and a relationship between said subject and said object,
querying said Large Language Model whether said statement is true or false, producing a first response,
querying the true/false classifier of claim 1 whether said statement is true or false, producing a second response,
comparing said first response to said second response.

15. A method for comparing the assayed qualities of a first Large Language Model and a second Large Language Model, comprising the steps of:
assaying the quality of said first Large Language Model using a true/false classifier created according to the method of claim 1, producing a first assay result,
assaying the quality of said second Large Language Model according to said true/false classifier, producing a second assay result, comparing said first assay result to said second assay result.

16. A method of selecting a trusted Large Language Model comprising the steps of:
comparing the assayed qualities of a first Large Language Model and a second Large Language Model wherein said first Large Language Model has a known level of trust.
